(19) United States
(12) Patent Application Publication
(10) Pub. No.: US 2013/0277077 A1
(43) Pub. Date: Oct. 24, 2013

(54) MACHINE TOOL

(71) Applicant: HILTI AKTIENGESELLSCHAFT, Schaan (LI)

(72) Inventors: Markus Hartmann, Mauerstetten (DE); Eduard Pfeiffer, Halblech (DE)

(21) Appl. No.: 13/865,729

(22) Filed: Apr. 18, 2013

(30) Foreign Application Priority Data
Apr. 19, 2012 (DE) 102012206445.1

(51) Int. Cl. B25D 17/24; B25D 9/06

(52) U.S. Cl. CPC B25D 17/245; B25D 9/06
USPC 173/1; 173/212

(57) ABSTRACT

A hand-held machine tool includes a tool accept for mounting a chiseling tool on an operating axis. A pneumatic hammer mechanism includes a hammer mobile on an operating axis, an exciter, and a pneumatic chamber sealed by an exciter and the hammer, which couples the movement of the exciter to the hammer. The exciter is driven by a motor and moves back and forth between a frontal dead point distant from the tool and a dead point near the tool. A damper device includes a supercharger and a controlled outlet valve. The controlled outlet valve allows air to flow from the supercharger into the pneumatic chamber when the exciter is in the proximity of the dead point distant from the tool.

### CROSS-REFERENCE TO RELATED APPLICATIONS

The present application claims priority to German Patent Application No. DE 10 2012 206 445.1, filed Apr. 19, 2012, which is hereby incorporated by reference herein in its entirety.

### FIELD

The present technology relates to a hand-held or hand-guided machine tool having a pneumatically acting hammer mechanism, e.g., an electric hammer drill, an electric chipper.

### BACKGROUND

DE 28 54 953 C2 describes a hammer drill that includes a hammer, which is excited via a motor-driven piston with an interposed pneumatic chamber. The effectiveness and the power level of the hammer drill is increased by a radial compressor. Air, supercharged by the radial compressor, flows through openings, which can be covered by the hammer, into the pneumatic chamber. The radial compressor increases the air pressure in the pneumatic chamber particularly at the point of time or during the period causing the optimal acceleration of the hammer, for example. Shortly before impinging a rivet set, the hammer is provided with additional thrust to increase the impact energy.

The user must apply a holding force when energy is transferred to the hammer. The transfer occurs periodically with the hammer frequency, typically ranging from 10 Hz to 100 Hz of the hand-held machine tool, resulting in the user experiencing the holding force as vibrations. The vibrations should be kept low, for physiological reasons. Accordingly, the impact energy cannot be increased indefinitely.

### DISCLOSURE

A hand-held machine tool according to certain aspects of the present technology includes a tool accept for mounting the chiseling tool on an operating axis. A pneumatic hammer mechanism includes a mobile hammer on its operating axis, an exciter, and a pneumatic chamber, sealed by the exciter and the hammer, which couples the movement of the exciter to the hammer. The exciter is driven by a motor and moves back and forth between a front dead point, distant from the tool, and a dead point near the tool. A damping device includes a supercharger and a controlled outlet valve. The controlled outlet value allows air to flow in from the supercharger into the pneumatic chamber when the exciter is in the proximity of the dead point distant from the tool.

The pneumatic chamber forms a so-called air spring, which transfers forces between the exciter and the hammer. The coupling strength reduces faster than linear in reference to the distance from the exciter and the hammer. Accordingly, a short time frame develops in which the exciter transfers the energy to the hammer for the next impact. The transfer occurs when the exciter has traveled half way between its dead points.

The present hand-held machine tool increases the pressure already before the hammer approaches the exciter, i.e. before the exciter has traveled half the distance between its dead points. Here, the exciter has its fastest speed and can transmit energy with maximum efficiency. With the increased pressure the coupling strength increases. The exciter can therefore transfer considerable energy to the hammer. Thus the period for energy transmission increases and the peak forces developing are reduced.

In some embodiments, the distance of the exciter from the dead point distant from the tool preferably amounts to less than 5% of the stroke of the exciter when the controlled outlet valve allows air to flow from the supercharger into the pneumatic chamber. Here, it must be considered particularly that the pressure generated by the compressor slows down the hammer. If this occurs too early or too severely, the hammer cannot reach the exciter any more when the latter moves with its maximum speed.

The supercharger includes a pumping device. The pumping device may be a pumping device operating independently from the hammer mechanism or a pumping device mechanically coupled with the hammer mechanism. For example, the exciter may form a pump plunger of the pumping device. An area of the exciter pointing opposite the direction of impact seals a compressor chamber of the pumping device and thus compresses/decompresses the compression chamber by its movement.

Some embodiments may include a cup-shaped guide tube. In the guide tube, on the operating axis, the hammer, the pneumatic chamber, the exciter, and the compression chamber of the pumping device are arranged opposite the direction of impact. A bottom seals the compression chamber in the guide tube opposite the direction of impact.

Some embodiments may include a piston rod coupling the exciter to the eccentric or a wobble drive. The piston rod may be guided through the bottom.

Some embodiments may include a guide tube in which the exciter is guided in an air-tight fashion. The guide tube may include at least one recess in its interior surface near the [dead point] distant from the tool. A channel forms between the pneumatic chamber and the compressor when the exciter assumes a position opposite the recess. Some embodiment may include a return valve in the exciter.

Some embodiments include a valve connecting the pneumatic chamber with a pumping chamber when the exciter is in the proximity of the dead point near the tool. A pumping device lowers a pressure in the pumping chamber below the level of the ambient pressure until the exciter reaches the dead point distant from the tool. The pumping chamber may be sealed in the direction of impact by the mobile exciter.

A control method for the hand-held machine tool may include increasing the air pressure in the pneumatic chamber via a supercharger when the exciter is near the dead point distant from the tool. Here, the air pressure in the pneumatic chamber rises faster than occurring by the mere approaching of the hammer towards the exciter. Further, air pressure in the pneumatic chamber can be lowered via the pumping device when the exciter is near the dead point near the tool. The air pressure therefore reduces faster than it occurs merely by the exciter separating from the hammer.

### BRIEF DESCRIPTION OF THE DRAWINGS

FIG. 1 is a hammer drill

FIGS. 2 to 4 is a hammer mechanism of the hammer drill in a longitudinal cross section

FIG. 5 is another hammer mechanism

FIG. 6 is another hammer mechanism

FIG. 7 is another hammer mechanism

### EMBODIMENTS

Identical elements or those performing identical functions are indicated with the same reference character in the figures, unless stipulated otherwise.

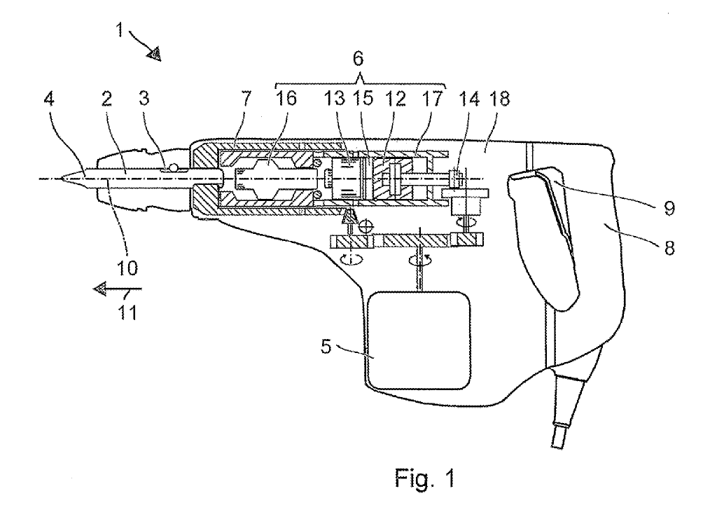

FIG. 1 shows schematically a hammer drill 1 as an example of a chiseling hand-held machine tool. The hammer drill 1 includes a tool accept 2, in which the end of a shaft 3 of a chiseling tool, e.g., a drill bit 4 can be inserted. A motor 5 forms the primary drive of the hammer drill 1, driving a hammer mechanism 6 and a driven shaft 7. A user can guide the hammer drill 1 via a handle 8 and start the operation of the hammer drill 1 via a system switch 9. During operation the hammer drill 1 can continuously rotate the drill bit 4 about an operating axis 10 and here the drill bit 4 can impact the underground in the direction of impact 11 along the operating axis 10.

The hammer mechanism 6 may be a pneumatic hammer mechanism 6. An exciter 12 and a hammer 13 may be guided in a mobile fashion in the hammer mechanism 6 along the operating axis 10. The exciter 12 may be coupled via an eccentric 14 or a wobble finger to the motor 5 and forced to perform a periodic, linear motion. An air spring, formed by a pneumatic chamber 15 between the exciter 12 and the hammer 13, couples a motion of the hammer 13 to the motion of the exciter 12. The hammer 13 can directly impact a rear end of the drill bit 4 or transmit a portion of its impulse to the drill bit 4 via an essentially stationary rivet set 16. For example, the hammer 13 and the exciter 12 may be embodied as pistons, which are arranged in a guide tube 17. The hammer mechanism 6 and preferably the other drive components too are arranged inside a machine housing 18.

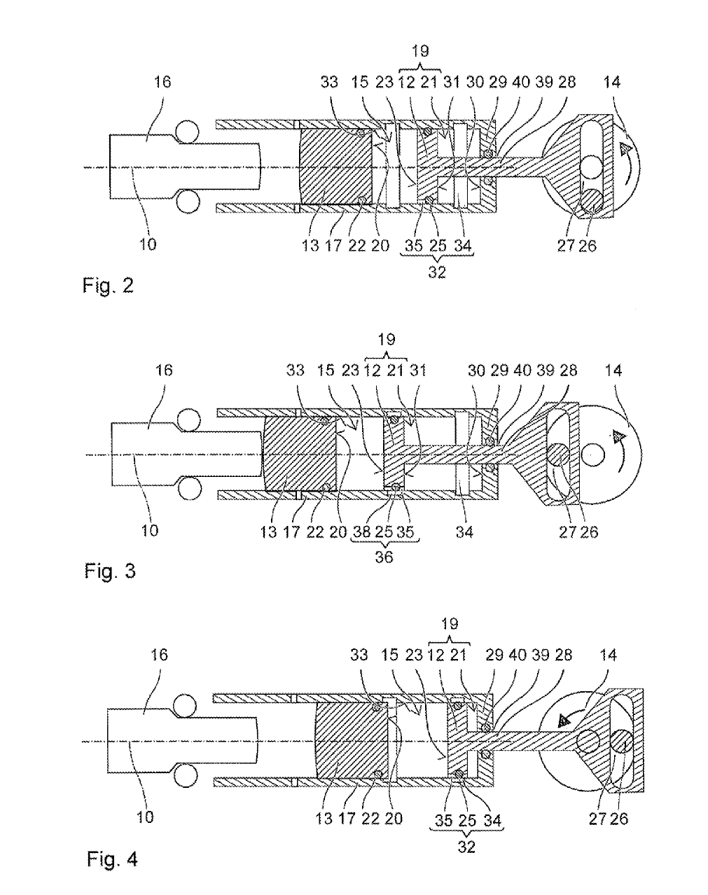

FIG. 2 shows in greater detail the pneumatic hammer mechanism 6 and a supercharger 19 in a longitudinal cross section.

The hammer 13 is a cylindrical piston, for example, which is also guided longitudinally along the operating axis 10 in the guide tube 17. A face 20 of the hammer 13 pointing opposite the direction of impact 11 forms another mobile side wall of the pneumatic chamber 21. The diameter of the hammer 13 is equivalent to the internal diameter of the guide tube 17. An O-ring 22 surrounding the hammer 13 supports the air-tight seal.

The exciter 12 may be a cylindrical piston, for example, guided along the operating axis 10 in a guide tube 17. A face 23 of the exciter 12 pointing in the direction of impact 11 forms a mobile side wall of the pneumatic chamber 15. A diameter of the exciter 12 is equivalent to the internal diameter of the guide tube 17. A jacket surface 24 of the exciter 12 seals the guide tube 17 in an airtight fashion. An O-ring 25 supports the air-tight seal of the pneumatic chamber 15. The pneumatic chamber 15 is therefore sealed opposite the direction of impact 11 by the exciter 12, in the direction of impact 11 by the hammer 13, and in the radial direction by the guide tube 17.

The exciter 12 is mechanically driven by the motor 5. An eccentric wheel 14, driven by the motor 5, forces the exciter 12 to a periodic movement back and forth between a dead point (FIG. 3) distant from the tool and a dead point near the tool. A pin 26 of the eccentric wheel 14 engages a link 27 extending perpendicular in reference to the rotational axis of the eccentric wheel 14 perpendicular in reference to the operating axis 10. The link 27 is recessed in the piston rod 28 and guided along the operating axis 10. The piston rod 28 is connected fixed to the exciter 12.

The guide tube 17 is sealed air-tight with a bottom 29 at its end distant from the tool. The bottom 29 is arranged on the side of the exciter 12 opposite the hammer 13. The bottom 29 shows a bottom area 30 facing the exciter 12, which is preferably embodied in a planar fashion. A facial area 31 of the exciter 12 facing the bottom 29 is preferably embodied in a planar fashion. The guide tube 17 is sealed circumferentially about the operating axis 10 between the bottom 29 and the exciter 12, this way forming a second pneumatic chamber 21. The second pneumatic chamber 21 represents the compression chamber 21 of a supercharger 19.

The exciter 12 cyclically compresses the air inside the compression chamber 21. The entirely compressed volume, i.e., when the exciter 12 is located in the dead point (FIG. 3) distant from the tool, may amount to from 10% to 20% of the maximum volume, i.e., when the exciter 12 is in the dead point (FIG. 4) near the tool.

The supercharger 19 is connected via an outlet valve 32 to the pneumatic chamber 15 of the hammer mechanism 6. The exemplary outlet valve 32 opens via a control edge, which is inserted e.g., as an annular recess 38 in the internal wall 33 of the guide tube 17. The radial seal of the exciter 12 with the internal wall 33 of the guide tube 17 is interrupted by a recess 34. The recess 34 is of such depth that the O-ring 25 is not in contact with the guide tube 17 in the area of the recess 34. The O-ring 25 seals the groove 35 along the operating axis 10. The valve 36 is open when the O-ring 25 with its axial height coincides flush with the recess 34. The air can pass between the radial external area of the O-ring 25 and the area of the recess 34. In its jacket surface 37 the exciter 12 preferably shows at least one groove 35 extending longitudinally in reference to the operating axis 10, open at both opposite faces 23, 31. The air can flow in the groove 35 towards the O-ring 25.

The outlet valve 32 and/or the recess 38 are positioned such that the outlet valve 32 opens in the dead point of the exciter 12, distant from the tool (FIG. 3). The outlet valve 32 opens preferably at the earliest when the exciter 12 has approached the dead point, distant from the tool, by up to 5% of its stroke. The outlet valve 32 closes at the latest when the exciter 12 is moved away from the dead point distant from the tool by more than 5% of its stroke. While the outlet valve 32 opens and the supercharger 21 increases the pressure in the pneumatic chamber 21 the hammer 13 moves opposite the direction of impact 11. The outlet valve 32 is closed considerably before the hammer 13 reaches its reversal point distant from the tool. The coupling of the hammer 13 to the exciter 12 for the transfer of energy increases with rising air pressure. Due to the supercharged air the coupling occurs earlier, resulting in the transfer of energy occurring over a longer period of time. Accordingly, the holding force required from the user reduces.

An inlet valve 36 may connect the supercharger 21 to the pneumatic chamber 21. The exemplary inlet valve 36 is based on a control edge, which is formed by an annular recess 38 in the guide tube 17. The O-ring 25 in the exciter 12 forms the corresponding sealing element. As soon as the O-ring 25 reaches the axial height of the recess 38 the inlet valve 36 opens. The inlet valve 36 and/or the recess 38 are positioned such that it opens together with the exciter 12 near the dead point close to the tool (FIG. 4). Preferably the inlet valve 36 opens when the distance of the exciter 12 from its dead point near the tool amounts to less than 3% of its stroke. The opening of the second valve 36 preferably coincides with the impact of the hammer 13 on the rivet set 16 or is slightly delayed in reference to the impact. The air pressure in the pneumatic chamber 21 is greater than in the compression chamber 21, which causes air flow from the pneumatic chamber 21 into the compression chamber 21. The reduction in pressure causes an acceleration of the hammer 13 opposite the direction of impact 11. This way, the slow-down of the hammer 13 due to the above-described increased air pressure after the opening of the first valve 34 can be partially compensated.

At the operating axis 10 the bottom 29 is provided with a penetration 39 for the piston rod 28. An O-ring 40 ensures for an air-tight seal of the penetration 39.

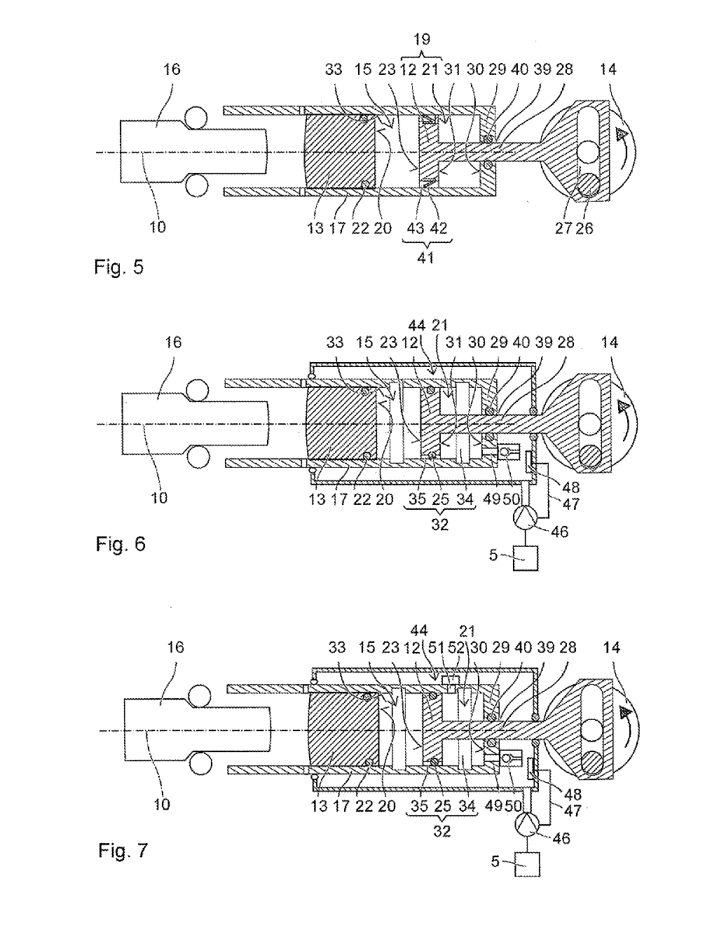

FIG. 5 illustrates a variant of the outlet valve 41 for the supercharger 21. The outlet valve 41 is a pressure-controlled return valve 42. The outlet valve 41 can be for example inserted into the exciter 12. A channel 43 connects the opposite faces 23, 31 of the exciter 12. The exemplary channel 43 is for example a groove 35 in the jacket surface 37 of the exciter 12. The return valve 42 is preferably pre-stressed and seals the channel 43 in the neutral position. The return valve 42 may be made from rubber, for example.

The outlet valve 41 opens when the pressure in the compression chamber 21 exceeds the pressure in the pneumatic chamber 21 by at least a threshold. The threshold amounts to 1 bar, for example. A respective pressure difference results when the exciter 12 approaches the dead point distant from the tool. The outlet valve 32 closes considerably before the hammer 13 reaches its return point distant from the tool.

FIG. 6 illustrates a variant of the hammer mechanism 6, which is based for example on the illustration of FIG. 2. In the alternative embodiment the supercharger 19 is provided with a greater volume. The compression chamber 21 is expanded by a pump reservoir 44. The pump reservoir 44 is for example formed by a closed cover 45 about the hammer mechanism 6. The volume of the pump reservoir 44 is preferably greater than the volume of the air spring 15, e.g., from the two-fold to the five-fold volume. The volume of the air spring 15 is defined as the volume when the hammer 13 impacts the rivet set 16 and the exciter 12 is in the dead point near the tool (FIG. 3). In an alternative embodiment the pump reservoir 44 may be embodied as a closed volume next to the hammer mechanism 6.

The pump reservoir 44 may be filled by a pump 46. The pump 46 may, for example, be a membrane pump. The pump 46 can be driven electrically or by a separate drive or via the motor 5 of the hammer drill 1. The pump 46 is continuously active and fills air into the pump reservoir 44. A control 47 with an air pressure sensor 48 may advantageously limit the pumping power of the pump 46 such that a constant target pressure develops in the pump reservoir 44. The target pressure depends on the maximum air pressure in the compressed air spring 15. In some embodiments, the target pressure ranges from 20% to 50% of the maximum air pressure, for example. In some embodiment, the air pressure in the air spring reaches a maximum value of from 10 bar to 20 bar.

An opening 49 in the compression chamber 21 connects it with the pump reservoir 44. A return valve 50 at the opening 49 prevents any air from flowing back from the chamber 21 into the pump reservoir 44. In the compression chamber 21 a higher pressure can develop in reference to the pump reservoir 44 until the exciter 12 has reached the dead point distant from the tool.

The outlet valve 32 formed in the exciter 12 controls the influx of air from the pump reservoir 44 into the pneumatic chamber 15 of the air spring. The opening 51 to the pump reservoir 44 can alternatively or additionally be provided in the guide tube 17. The opening 51 is preferably provided between the position of the exciter 12 in its dead point near the tool and its dead point distant from the tool (FIG. 7). The exciter 12 itself forms the sealing body for a valve, sealing and/or opening the opening in reference to the pneumatic chamber. The distance from the dead point distant from the tool is given for example at a range from 3% to 5% of the stroke of the exciter 12.

The valve 52 can also be controlled electrically or magnetically. The control of the valve 52 may occur based on a position of the exciter 12 in the pneumatic chamber 21. The valve 52 is opened when the exciter 12 is near the dead point distant from the tool, e.g., approximately at a distance of 3% to 5% of the stroke. In some embodiments, the valve 52 can only open after the exciter 12 has exceeded the dead point distant from the tool. The valve 52 may be closed after the distance from the dead point distant from the tool exceeds a predetermined percentage of the stroke, such as 3% to 5% of the stoke, for example.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A hand-held machine tool with a tool accept for mounting a chiseling tool on an operating axis, comprises
a pneumatic hammer mechanism comprising a mobile hammer on said operating axis, with an exciter driven back and forth by a motor between a frontal dead point, distant from the tool, and a dead point near the tool, and a pneumatic chamber sealed from the exciter and the hammer to couple the movement of the exciter to the hammer; and
a damping device comprising a supercharger and a controlled outlet valve, with the controlled outlet valve allowing air to flow from the supercharger into the pneumatic chamber when the exciter is in the proximity of the dead point distant from the tool.

2. A hand-held machine tool according to claim 1, wherein a distance of the exciter from its dead point distant from the tool is lower than 5% of the stroke of the exciter when the controlled outlet valve allows air to flow from the supercharger into the pneumatic chamber.

3. A hand-held machine tool according to claim 1, wherein the supercharger includes a pumping device.

4. A hand-held machine tool according to claim 3, wherein the exciter forms a pumping piston of the pumping device.

5. A hand-held machine tool according to claim 4, wherein an area of the exciter facing opposite the direction of impact seals a compression chamber of the pumping device.

6. A hand-held machine tool according to claim 5, further comprising a cup-shaped guide tube, in which the hammer, the pneumatic chamber, the exciter, and the compression chamber of the pumping device are on the operating axis opposite the direction of impact and a bottom seals the compression chamber in the guide tube opposite the direction of impact.

7. A hand-held machine tool according to claim 4, further comprising a piston rod coupling the exciter with an eccentric or a wobble drive and the piston rod is guided through the bottom.

8. A hand-held machine tool according to claim 1, wherein a guide tube, in which the exciter is guided in an air-tight fashion, with the guide tube comprising at least one recess in its internal surface near the dead point distant from the tool, at which a channel forms with the exciter opposite thereto between the pneumatic chamber and the compactor.

9. A hand-held machine tool according to claim 1, further comprising a return valve arranged in the exciter.

10. A hand-held machine tool according to claim 1, further comprising a valve which connects the pneumatic chamber to a pumping chamber when the exciter is in the proximity of the dead point near the tool, and a pumping device lowering a pressure in the pumping chamber below the level of ambient pressure until the exciter has reached the dead point near the tool.

11. A hand-held machine tool according to claim 10, wherein the pumping chamber is sealed in the direction of impact by a mobile exciter.

12. A control method for a hand-held machine tool, comprising a tool accept for mounting a chiseling tool on an operating axis and a pneumatic hammer mechanism, with the hammer mechanism comprising a hammer mobile in the operating axis, an exciter driven by a motor and moving back and forth between a front dead point distant from the tool and a dead point near the tool and a pneumatic chamber sealed by the exciter and the hammer for coupling the movement of the exciter to the hammer, comprising:
increasing the air pressure in the pneumatic chamber via a supercharger when the exciter is in the proximity of the dead point distant from the tool.

13. A control method according to claim 12, further comprising lowering the air pressure in the pneumatic chamber via a pumping device when the exciter is in the proximity of the dead point near the tool.
